(19) United States
(12) Patent Application Publication
(10) Pub. No.: US 2010/0165228 A1
(43) Pub. Date: Jul. 1, 2010

(54) LIQUID CRYSTAL DISPLAY WITH A HEIGHT ADJUSTABLE BASE FOR THE PANEL THEREOF

(75) Inventor: HSIU-MEI SHEN, Hsin Tien City (TW)

Correspondence Address: G. LINK CO., LTD., 3550 BELL ROAD, MINOOKA, IL, 60447, US

(73) Assignee: UNITED FU SHEN CHEN TECHNOLOGY CORP., Hsin Tien City (TW)

(21) Appl. No.: 12/354,789

(22) Filed: Jan. 16, 2009

(30) Foreign Application Priority Data
Dec. 26, 2008 (TW) 097223401

(51) Int. Cl. G02F 1/1333

(52) U.S. Cl. 349/58

(57) ABSTRACT

A liquid crystal display with a height adjustable base assembly includes a base, an inclinable main arm, which is provided with a pivotal connection with the base and has slide rails, a panel fixing frame, which is capable of ascending and descending along the slide rails and has a locating groove, and a lock device, which is disposed between the main arm and the base and provides a locating pin member. When the main arm rotates a preset inclining angle relative to the base, the locating pin member is pushed to engage with the locating groove such that the operation of ascending and descending the panel fixing frame with respect to the main arm is locked. Hence, the liquid crystal panel bouncing outward suddenly during unpacked is avoided to secure the safety with convenient operations.

### BACKGROUND OF THE INVENTION

1. Field of the Invention

The present invention is related to a liquid crystal display, and particularly to a liquid crystal display with a height adjustable base incorporating with a function of locking the ascending and descending movements of the liquid crystal panel thereof.

2. Brief Description of the Related Art

Due to the information technology being developed rapidly, the monitor with screen display is widely applied for showing pictures such as graphical images. The traditional cathode ray tub (CRT), which had been popularly used for a long time, has been largely replaced with the liquid crystal display (LCD), which is light in weight and thin in thickness.

In order to allow the height or the inclining angle of the liquid crystal panel on the liquid crystal display placed on the desktop being adjustable according to the preference of the user, it is necessary to have an adjustment device on the liquid crystal display for meeting the need of the user from the standpoint of the comfortable operation.

The conventional height adjustable base on the liquid crystal display offers an upward elastic force with a constant force spring. Because the locating of the height adjustable base is achieved by means of the gravity of the liquid crystal panel balancing with the upward elastic force of the constant force spring, the ascending and descending movements of the height adjustable base work normally only if the liquid crystal display is operated normally. The liquid crystal panel is usually descended to the lowest position with a forward inclining angle 90° before the liquid crystal display is packed for delivering. But, it is very possible that the liquid crystal panel bounces outward suddenly to hurt people at the time of the liquid crystal display being unpacked. Hence, how to avoid the preceding deficiency and secure the safety of the people is a subject worth us to investigate thoroughly.

### SUMMARY OF THE INVENTION

Accordingly, an object of the present invention is to provide a liquid crystal display with a height adjustable base, which has a function of locking the ascending and descending movements, such that when the forward inclining angle of the liquid crystal panel is greater than a certain angle, the operation of ascending and descending the liquid crystal panel is capable of being locked during the liquid crystal display being unpacked to prevent the liquid crystal panel from bouncing outward suddenly and to enhance the convenience of the operation.

In order to achieve the preceding object, a liquid crystal display with a height adjustable base for the panel thereof according to the present invention includes a liquid crystal display and a height adjustable base, and the height adjustable base further includes a base, an inclinable main arm, a panel fixing frame and a lock device.

Wherein, the inclinable main arm has a pivotal connection with the base and has a slide rail at two opposite lateral sides thereof respectively; the panel fixing frame is mount with the liquid crystal panel has a locating groove and is capable of offering the liquid crystal panel ascending and descending along the rail; and the lock device is disposed between the inclinable main arm and the base and has a locating pin member, which is capable of being pushed to engage with the locating groove, such that the operational function for the ascending and the descending movements of the panel fixing frame on the main arm is locked after the inclinable main arm is rotated to a preset inclining angle with respect to the base.

In the preferred embodiment of the present invention, the lock device further comprises a pin holding seat assembly, a compression spring, the preceding locating pin member, a movable block member and a linkage. Wherein, the pin holding seat assembly is fastened to the main arm and has a locating pin seat and an axial hole; the locating pin member has a locating pin head, an upper slant and a lower locating jut with the locating pin head penetrating the compression spring and the axial hole to join with the locating pin seat; and the sliding block presses against the upper slant at the time of the movable block member moving upward and downward such that the locating pin member is capable of moving forward and backward due to the movable block member moving upward and downward incorporating with an elastic force of the compression spring. The linkage device is disposed between the base and the movable block member to urge the movable block member to ascend and descend when the main arm rotates to a preset inclining angle with respect to the base.

In the preferred embodiment of the present invention, the pin holding seat assembly of the lock device has an upper hook; the movable block member has a lower hook; and the linkage device further comprises an extension spring and a flexible line, wherein two ends of the extension spring engage with the upper hook and the lower hook respectively to offer an elastic force for ascending the movable block member; and two end of the flexible line are joined to the base and the movable block member to offer a pull force for descending the movable block member.

In the preferred embodiment of the present invention, the movable block member of the lock device has an adjustable screw and an end of the flexible line is attached to the adjustable screw for the preset inclining angle, which is obtained at the time of the main arm rotationally inclining forward for locking the ascending and descending movements, being capable of being micro-adjusted. Further, the operation of the ascending and descending movements is locked when the preset inclining angle of the main arm is not less than 5°.

In the preferred embodiment of the present invention, the base provides a rotational foot pad in the middle of the bottom thereof for the liquid crystal panel being swung rightward and leftward.

When the liquid crystal display in a state of normal use, the liquid crystal panel is braked with the inclinable connection mechanism and is operated between an inclining forward 5° and an inclining rearward 25°. Meanwhile, the flexible line of the lock device is in a state of tightness such that the movable block member is pulled downward by the flexible line to urge the locating pin member moving outward the locating groove of the panel fixing frame due to the upper slant of the locating pin member being pressed by the movable block member. Hence, the function of ascending and descending the liquid crystal panel is maintained normally.

Besides, before the liquid crystal display being packed, the liquid crystal panel is descended to a position first where the locating groove of the panel fixing frame corresponds to the locating pin member of the lock device and then the liquid crystal panel is rotated to incline forward an angle not less than 5° (generally the angle is 90°). Right at this time, the flexible line of the lock device is in a state of looseness such that the movable block member is moved upward with the elastic force of the extension spring and the locating pin member moves forward to engage with the locating groove. Under this circumference, the operations for ascending and descending the liquid crystal panel being locked and incapable of bouncing outward to hurt people during the liquid crystal display being unpacked.

When the liquid crystal display of the invention is unpacked and taken out, the forward inclining angle of the liquid crystal panel can be adjusted to be less than 5° (or inclining backward) to restore the operational function automatically for ascending and descending the liquid crystal panel smoothly with safety and convenience.

### BRIEF DESCRIPTION OF THE DRAWINGS

The detail structure, the applied principle, the function and the effectiveness of the present invention can be more fully understood with reference to the following description and accompanying drawings, in which:

FIG. 1 is a perspective view of a liquid crystal display according to the present invention;

FIG. 2 is a partial disassembled perspective view of the liquid crystal display shown in FIG. 1;

FIG. 3 is an exploded perspective view of the height adjustable base shown in FIG. 2;

FIG. 4 is another perspective view of the height adjustable rotational main shaft shown in FIG. 3;

FIG. 5 is an exploded perspective view of the height adjustable lock device shown in FIG. 3; and

FIG. 6 is another perspective view of the height adjustable base shown in FIG. 2.

### DETAILED DESCRIPTION OF THE INVENTION

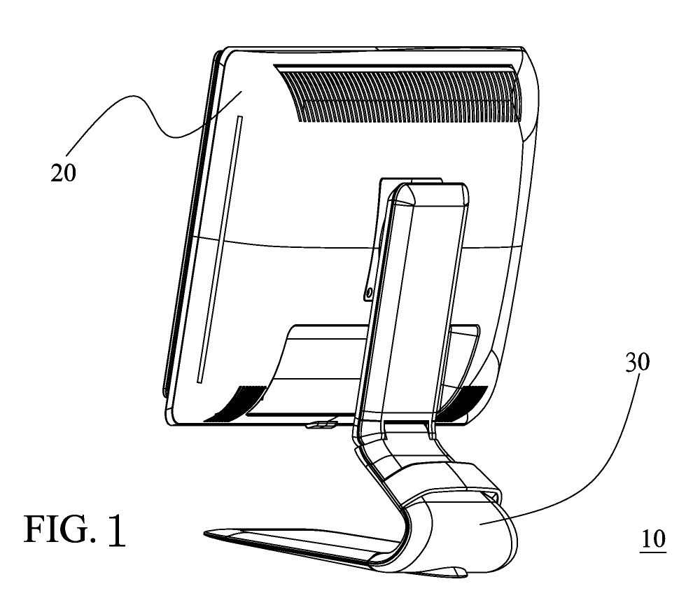

Referring to FIGS. 1 to 6, the preferred embodiment of a liquid crystal display 10 according to the present invention includes a liquid crystal panel 20 and a height adjustable base assembly 30. The height adjustable base assembly 30 is composed of a base 31, an inclinable main arm 32, a panel fixing frame 33, a lock device 34 and a constant force spring 35. The base 31 has a plastic cover to embellish the outer look of the liquid crystal panel 20. The liquid crystal panel 20 is fastened to the panel fixing frame 33 of the height adjustable base 30 with screws.

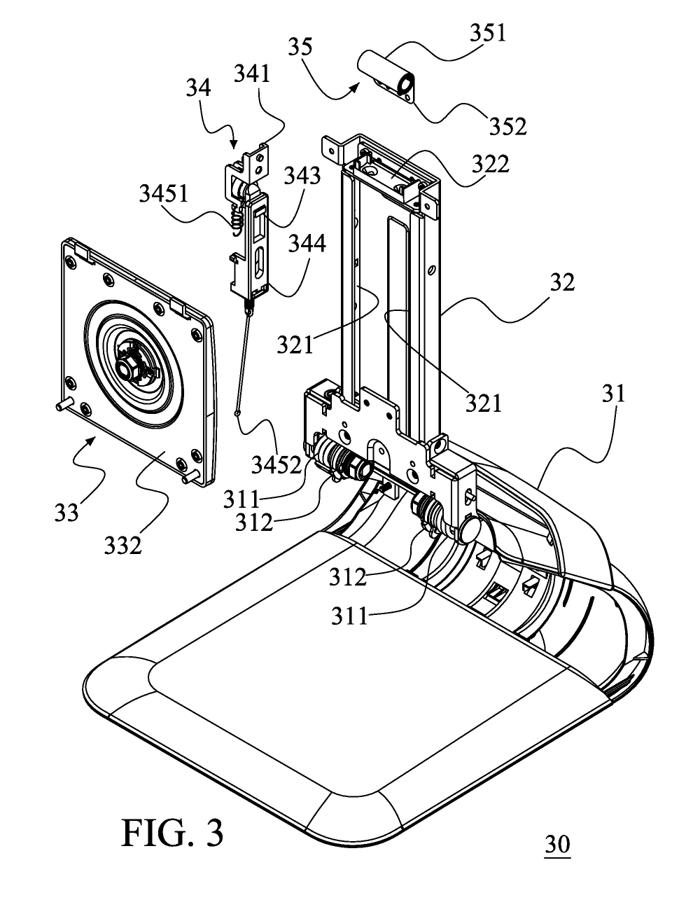

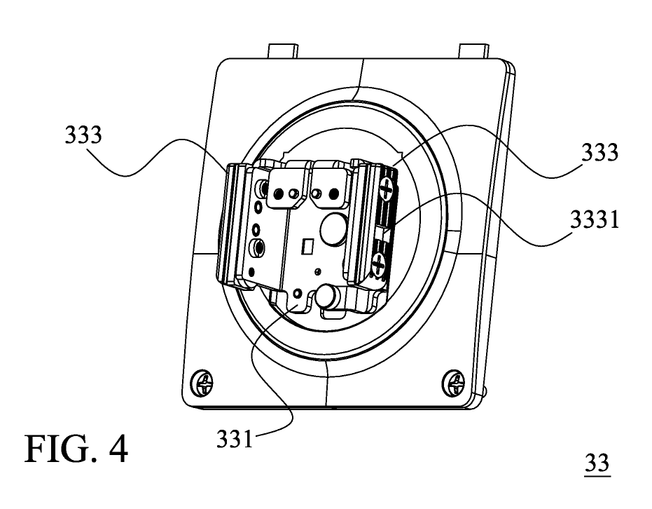

Besides, in order to offer the user more flexible applications, the panel fixing frame 33 consists of an ascending-descending seat 331 (See FIG. 4), which is capable of ascending and descending along the inclinable main arm 32, and a panel rotational seat 332 (See FIG. 3), which is braked with a braking device and rotationally joined to the ascending-descending seat 331. The liquid crystal panel 20 is fastened to the panel rotational seat 332 with screws for the user being able to turn and adjust the angular position of the liquid crystal panel 20 according to the need of picture displaying.

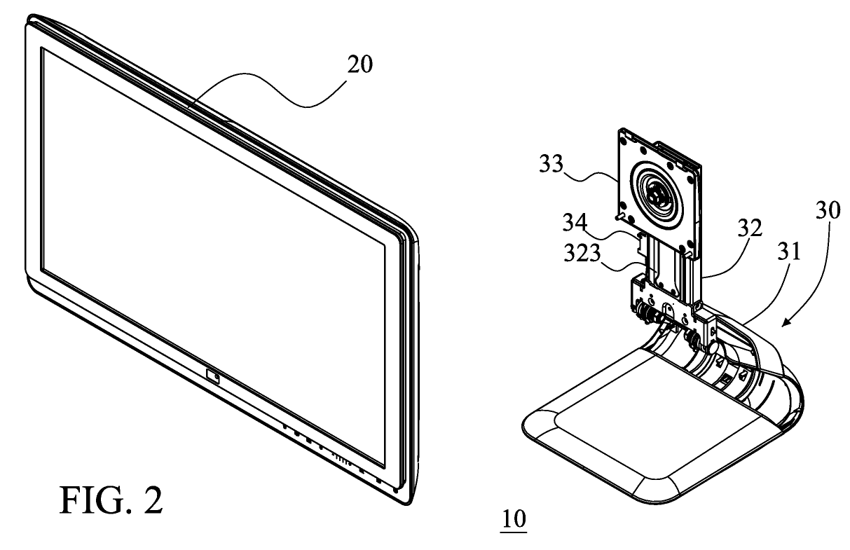

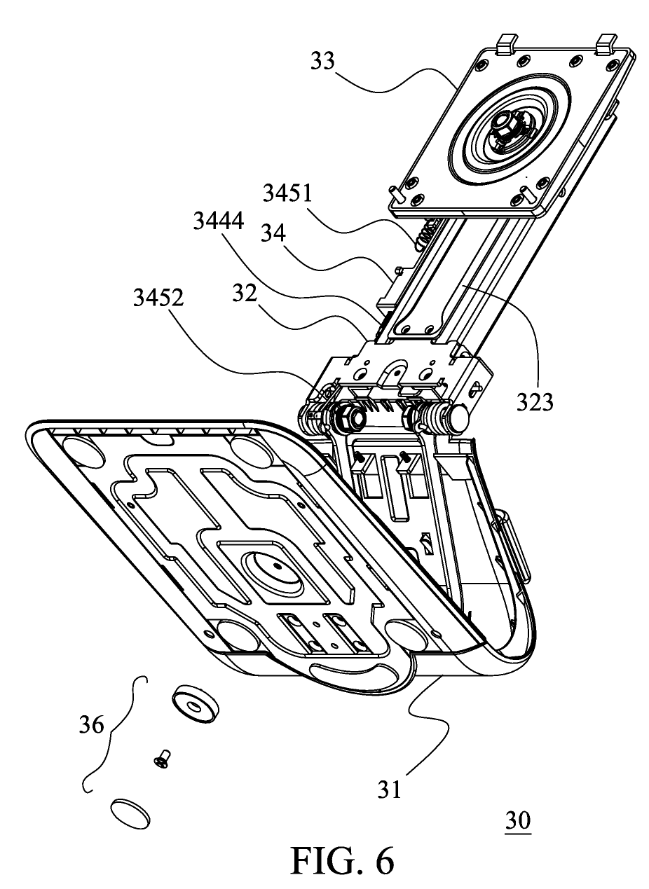

Referring to FIG. 3, the lower end of the inclinable main arm 32 is rotationally attached to the base 31 with a torsion spring 311 incorporated with the braking device, which is composed of such as a spring washer and an angular positioning plate 312, at two opposite corners of the lower end of the height adjustable main arm 32. In this way, the inclinable main arm 32 is capable of being operated to have an inclining angle with respect to the base 31 between a forward inclining angle 90° and a rearward inclining angle 25°. A slide rail 321 is provided at two long lateral sides of the inclinable main arm 32 respectively. It is noted that a reinforcing plate 323, which is disposed at the inclinable main arm 32 next to the slide rails 321 (See FIGS. 2 and 6) has been removed in FIG. 3. Each of the slide rails 321 can be a shape of channel as shown in FIG. 3 or any other shapes, which are able to provide a function of guidance. A sliding block 333 shown in FIG. 4 is disposed at two lateral sides of the ascending-descending seat 331 of the panel fixing frame 33 corresponding to the slide rails 321 such that the liquid crystal panel 20 is capable of moving upward and downward along the slide rails 321. Further, one of the sliding blocks 333 is provided with a locating groove 3331.

It can be seen in FIGS. 3 and 4 that the position of the liquid crystal panel 20 is poised by means of an upward elastic force offered by the constant force spring 35 balancing with the gravity of the liquid crystal panel 20 after the sliding blocks 333 of the panel fixing frame 33 moving along the sliding rails 321 of the inclinable main arm 32. The constant force spring 35 has a movable end 352 disposed in a constant force spring seat 322 of the inclinable main arm 32 and a stationary end 352 is fastened to the upper end of the ascending-descending seat 331 on the panel fixing frame 33. In this way, when the panel fixing frame 33 descends, the constant force spring 35 is capable of offering the sufficient upward elastic force for the panel fixing frame 33 to balance with the gravity of the liquid crystal panel 20.

In addition, in order to allow the inclining main arm 32 having a preset inclining forward angle such as an angle is not less than 5°, a locating pin member 343 on the lock device 34 is urged to engage with the locating groove 3331 of the panel fixing frame 33 to lock the operation of the inclining main arm 32. The lock device 34 with the locating pin member 343 is disposed between the inclining main arm 32 and the base 31.

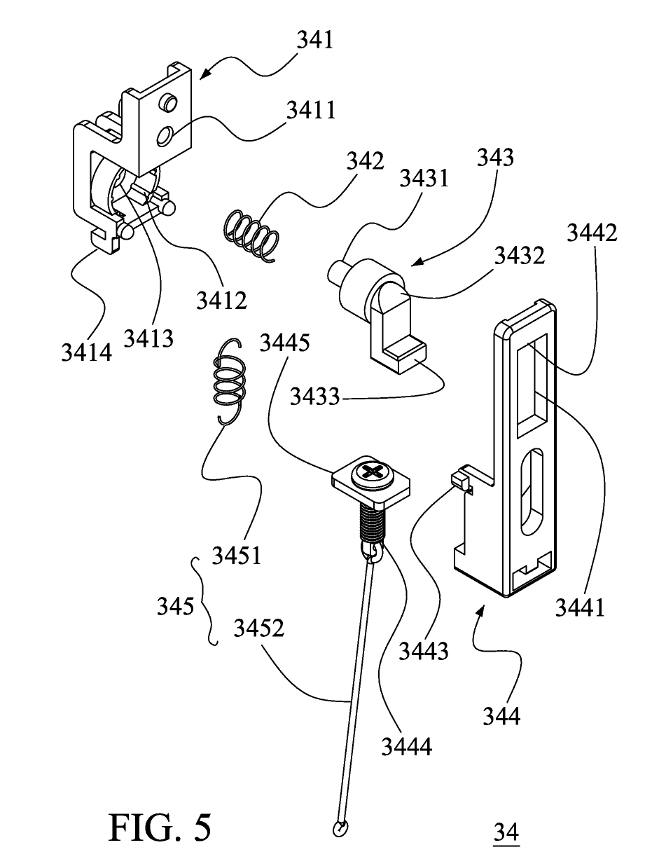

Referring to FIG. 5 again, the lock device 34 of the height adjustable base assembly 30 includes a pin holding seat assembly 341, a compression spring 342, the locating pin member 343, a movable block member 344 and a linkage device 345. The linkage device 345 is capable of transferring a rotational movement to a reciprocating movement. The linkage device 345 shown in FIG. 5 consists of an extension spring 3451 and a flexible line 3452. The material of the flexible line 3452 is a cord or wire with flexibility such as a plastic cord, a nylon cord, a steel wire or a metal chain. It is noted that the strength of the flexible line at least has to overcome the elastic force of the extension spring 3451 but no excessive extension or, even more, no breakage is allowed. The flexible line 3452 employed in the preferred embodiment is the KEVLAR® fiber cord made by DU PONT company.

It can be seen in FIG. 5 that the pin holding seat assembly 341 is fastened to a lateral side of the inclinable main arm 32 with screws passing through a hole 3411. The pin holding seat assembly 341 further includes a locating pin seat 3412, an axial hole 3413 and an upper hook 3414. The locating pin member 343 has a locating pin 3431, an upper slant 3432 and a locating jut 3433. The locating pin 3431 pierces the compression spring 342 and the axial hole 3413 and is secured to the locating pin seat 3412.

The movable block member 344 has a sliding groove 3441 and a lower hook 3443. The sliding groove 3441 receives the locating jut 3433 of the locating pin member 343. When the movable block member 344 ascends or descends, the locating pin member 343 is operated to move forward or backward by means of the upper surface of the sliding groove 3441 pressing against the upper slant 3432 of the locating pin member 343 incorporating with the elastic force of the compression spring 342. Both ends of the extension spring 3451 engage with the upper hook 3414 and the lower hook 3443 respectively. An end of the flexible line 3452 is tied to the angular positioning plate 312 on the base 31 (See FIG. 3) and another end of the flexible line 3452 is joined to the movable block member 344 via an adjustable screw 3444 and a reinforcing plate 3445. In this way, the operation of locking the inclinable main arm 32 with a micro-adjustment of a preset inclining angle can be achieved with turning the adjustable screw 3444. Of course, persons who is skillful in the art understand that the end of the flexible line 3452 tying to the angular positioning plate 312 can be tied to any one place on the base 31 as long as the place corresponds to the other end of the flexible line 3452 for the liquid crystal panel 20 being capable of inclining pivotally to meet the need of tightness or looseness.

The principle of operation for the lock device 34 of the liquid crystal panel 20 is in that the liquid crystal panel 20 is braked with the torsion spring 311 incorporating with the braking device such as the spring washer and the angular positioning plate 312 and is rotationally operated between a range of inclining forward 5° and inclining rearward 25° in a normal state. Meanwhile, the flexible line 3452 of the lock device 34 is in a state of tightness such that the movable block member 344 is pulled downward by the flexible line 3452 to urge the locating pin member 343 moving outward the locating groove 3331 of the panel fixing frame 33 due to the upper slant 3432 of the locating pin member 343 being pressed by the movable block member 344. Hence, the function of ascending and descending the liquid crystal panel 20 can be operated normally.

Furthermore, before the liquid crystal display 10 being packed, the liquid crystal panel 20 is descended to a position where the locating groove 3331 of the panel fixing frame 33 corresponds to the locating pin member 343 of the lock device 34 first and then the liquid crystal panel 20 is rotated to incline forward an angle not less than 5° (generally the angle is 90°). Right at this time, the flexible line 3452 of the lock device 34 is in a state of looseness such that the movable block member 344 moves upward due to the elastic force of the extension spring 3451 and the locating pin member 343 moving forward to engage with the locating groove 3331. Under this circumference, the operation for ascending and descending the liquid crystal panel 20 is locked and incapable of bouncing outward to hurt people during unpacking the liquid crystal display.

Referring to FIG. 6 again, the base 31 of the height adjustable base assembly 30 is provided with a pivotal foot pad 36 at the middle of the bottom of the base 31 for the liquid crystal panel 20 being able to be angularly swung rightward or leftward for enhancing the use of the liquid crystal display.

While the invention has been described with referencing to a preferred embodiment thereof, it is to be understood that modifications or variations may be easily made without departing from the spirit of this invention, which is defined by the appended claims.

What is claimed is:

1. A liquid crystal display comprising:
a liquid crystal panel;
a base;
an inclinable main arm having a pivotal connection with said base and having a slide rail at two opposite lateral sides thereof;
a panel fixing frame being mount with said liquid crystal panel, having a locating groove and being capable of ascending and descending along said rail; and
a lock device being disposed between said inclinable main arm and said base and having a locating pin member, which is capable of being pushed into said locating groove to lock an ascending and an descending movements of said panel fixing frame on said inclinable main arm after said inclinable main arm is rotated to a preset inclining angle with respect to said base.

2. The liquid crystal display as defined in claim 1, wherein said lock device further comprises following parts except said locating pin member:
a pin holding seat assembly being fastened to said main arm and having a locating pin seat and an axial hole;
a compression spring;
a movable block member having a sliding groove and being capable of moving upward and downward; and
a linkage device being disposed between said base and said movable block member to urge said movable block member to ascend and descend when said main arm rotates to a preset inclining angle with respect to said base;
wherein, said locating pin member has a locating pin, an upper slant and a lower locating jut with said locating pin penetrating said compression spring and said axial hole to join with said locating pin seat; and said sliding block presses against said upper slant at the time of said movable block member moving upward and downward such that said locating pin member is capable of moving forward and backward corresponding to said movable block member moving upward and downward incorporating with an elastic force of said compression spring.

3. The liquid crystal display as defined in claim 2, wherein said pin holding seat assembly has an upper hook, said movable block member has a lower hook and said linkage device further comprises:
an extension spring with two ends thereof engaging with said upper hook and said lower hook respectively; and
a flexible line with two end thereof being joined to said base and said movable block member.

4. The liquid crystal display as defined in claim 3, wherein said movable block member has an adjustable screw and an end of said flexible line is attached to said adjustable screw for said preset inclining angle being micro-adjustable.

5. The liquid crystal display as defined in claim 1, wherein said main arm is rotated forward with said preset inclining angle being not less than 5°.

6. The liquid crystal display as defined in claim 1, wherein said base provides a pivotal foot pad in the middle of a bottom thereof for being swung rightward and leftward.

7. A height adjustable base assembly for liquid crystal display comprising:
a base;
an inclinable main arm having a pivotal connection with said base and having a slide rail at two opposite lateral sides thereof;
a panel fixing frame being mount with said liquid crystal panel, having a locating groove and being capable of ascending and descending along said rail; and
a lock device being disposed between said inclinable main arm and said base and having a locating pin member, which is capable of being pushed into said locating groove to lock an ascending and a descending movements of said panel fixing frame on said inclinable main arm after said inclinable main arm is rotated to a preset inclining angle with respect to said base.

8. The height adjustable base assembly as defined in claim 1, wherein said lock device further comprises following parts except said locating member:
a pin holding seat assembly being fastened to said main arm and having a locating pin seat and an axial hole;
a compression spring;
a movable block member having a sliding groove and being capable of moving upward and downward; and
a linkage device being disposed between said base and said movable block member to urge said movable block member to ascend and descend when said main arm rotates to a preset inclining angle with respect to said base;
wherein, said locating pin member has a locating pin head, an upper slant and a lower locating jut with said locating pin penetrating said compression spring and said axial hole to join with said locating pin seat; and said sliding block presses against said upper slant at the time of said movable block member moving upward and downward such that said locating pin member is capable of moving forward and backward corresponding to said movable block member moving upward and downward incorporating with an elastic force of said compression spring.

9. The liquid crystal display as defined in claim 8, wherein said pin holding seat assembly has an upper hook, said movable block member has a lower hook and said linkage device further comprises:
an extension spring with two ends thereof engaging with said upper hook and said lower hook respectively; and
a flexible line with two end thereof being joined to said base and said movable block member.

10. The liquid crystal display as defined in claim 9, wherein said movable block member has an adjustable screw and an end of said flexible line is attached to said adjustable screw for said preset inclining angle being micro-adjustable.

11. The liquid crystal display as defined in claim 7, wherein said main arm is rotated forward with said preset inclining angle being not less than 5°.

12. The liquid crystal display as defined in claim 7, wherein said base provides a rotational foot pad in the middle of a bottom thereof for being swung rightward and leftward.
